(19) United States
(12) Patent Application Publication
(10) Pub. No.: US 2008/0282331 A1
(43) Pub. Date: Nov. 13, 2008

(54) User Provisioning With Multi-Factor Authentication

(75) Inventor: Wee Tuck Teo, Singapore (SG)

Correspondence Address: TRASK BRITT, P.O. BOX 2550, SALT LAKE CITY, UT, 84110, US

(73) Assignee: ADVANCED NETWORK TECHNOLOGY LABORATORIES PTE LTD, Singapore (SG)

(21) Appl. No.: 11/664,674

(22) PCT Filed: Oct. 8, 2004
(86) PCT No.: PCT/SG04/00328

§ 371 Date: Apr. 4, 2007

(51) Int. Cl. H04L 9/32

(52) U.S. Cl. 726/6; 726/5

(57) ABSTRACT

A method and system for authenticating a user in a network includes a network software client of a computing device requesting network software services from a service gateway. A call between a user phone and an IVR phone login system is initiated in response to the user phone and the computing device being within a coverage area of the service gateway. A location of a user uniquely assigned to the computing device is identified within the coverage area. A first information received in the network software services from the computing device is correlated with a second information received from the IVR phone login system. When the first and second information match, access by the computing device to services of the service gateway is allowed.

### TECHNICAL FIELD

The present invention relates to network connectivity. More particularly, the present invention relates to a user authentication process in a network.

### BACKGROUND

An ever increasing number of computer users demand connectivity to the Internet, or to some private or public domain network. With the ubiquitous nature of portable computers, laptops and PDAs or other networked computing devices, wired or wireless connectivity with a network is desirable. Furthermore, more and more computer or electronic applications are becoming available on-line, or are required to be accessed via a computer network. These two key trends present a new class of problems in many industries and situations.

Usually, users require some form of authentication or authorization process to allow the network to verify a user's identity and determine what network resources can be accessed, or if the connectivity itself is allowed. Even in open networks where access is essentially free, it may be useful to monitor or control the access to resources and network connectivity. In one exemplary deployed configuration, essentially anyone may access the network but with limitations, such as a time limitation wherein the user is limited to, for example, 15 minutes and must try to connect again after an expiry time.

Generally, users may be assigned one or more identities to differentiate them from other users. The differentiating identities may include a userid or a token key that is unique, and a password or piece of information that would allow the system to assume that the owner of the userid/token and password is the particular user that it purports to be. Sometimes, “physical” possession of a token, analogous to the physical possession of a key for a lock, is sufficient to gain access to the network or access to information and/or an application. Sometimes, a combination of more than one type of userid or token used together (e.g., multiple factor authentication) may be desired for stricter security requirements.

Additionally, connectivity conditions exist where the network must provide connectivity to new users whose identities are not known beforehand, in addition to those users (if any) who are known or already registered to the network system. A mechanism or method for allowing the system to identify each specific unknown or known user, and to control and access to network resources and connectivity is important for security reason, and also to ensure that some computer applications and network resources are used properly.

Conventional login mechanisms using userid and password suffer from operational overhead of user account maintenance and expiry. An extension to conventional login mechanisms includes a two-factor authentication which ensures userid and password stealing does not compromise security. All these authentication enhancements incur increasing overheads in order to increase security. This increases both the capital expenses and operational expenses. All these technological advances also increase the end user burden to login and access a service. Furthermore, support costs of assisting these end users also increases the operational cost with the increase in security basically sacrificing the end user ease of login.

Clearly, in scenarios where a login process or system is used to access paid services, security is of concern to avoid fraudulent usage. Additionally, balancing the end user experience and ease of use while maintaining adequate security is also of particular concern. Therefore, in a reconfigurable network, ease of use is important to ensure the customer can always get access to the paid service. Conversely, an unsatisfactory customer experience will incur higher support cost and might result in customer loss.

### DISCLOSURE OF INVENTION

A user provisioning with multi-factor authentication is provided. In one embodiment of the present invention, a method for authenticating a user in a network is provided. A network software client of a computing device requests network software service through a service gateway. A call between a user phone and an Interactive Voice Response (IVR) phone login system is initiated in response to the user phone and the computing device being within a coverage area of the service gateway. A user associated with a location within the coverage area is identified. A first information is received by the network software service from the computing device before asynchronously collecting a second information received from the IVR phone login system and correlating the first and second information. When the first and second information match, access by the computing device to services of the service gateway is allowed.

In another embodiment of the present invention, an authentication system is provided. The authentication system includes a computing device including a network software client configured to request network software services. The system further includes a gateway configured to host the network services and redirect the request for the network software services. The system also includes a user phone and an IVR phone login system configured to support a call with the user phone when the user phone and the computing device are located within a coverage area of the service gateway as uniquely assigned to the computing device. The service gateway and the IVR phone login system are further configured to correlate a first information received in the network software services from the computing device and a second information received from the IVR phone login system and when the first and second information match, access is allowed by the computing device to services of the service gateway.

A computer-readable medium including computer-executable instructions thereon is also provided for performing the steps of the method for authenticating a user in a network.

### BRIEF DESCRIPTION OF THE DRAWINGS

In the drawings, which illustrate what is currently considered to be the best mode for carrying out the invention:

FIG. 1 is a block diagram of a network configured for a two-factor login process using a wired phone, in accordance with an embodiment of the present invention;

FIG. 2 is a flow diagram of a multi-factor authentication process including an IVR system configured in an outbound arrangement, in accordance with another embodiment of the present invention;

FIG. 3 is a flow diagram of a multi-factor authentication process including an IVR system configured in an inbound arrangement, in accordance with another embodiment of the present invention;

FIG. 4 is a block diagram of a network configured for a multi-factor authentication process using a wireless phone, in accordance with a further embodiment of the present invention;

FIG. 5 is a flow diagram of a multi-factor authentication process using an outbound IVR system and a web-based cookie, in accordance with yet a further embodiment of the present invention;

FIG. 6 is a flow diagram of a multi-factor authentication process using an outbound IVR system for multi-user or denial of service (DoS) conditions, in accordance with an embodiment of the present invention; and

FIG. 7 is a block diagram of a network configured to restrict access to at least a portion of the available resources, in accordance with an embodiment of the present invention.

### BEST MODE(S) FOR CARRYING OUT THE INVENTION

In one form of a two-factor login process, a single authentication mechanism such as userid or password is sufficient to authenticate the user independently. In the one or more multi-factor login process embodiments of the present invention, the authentication mechanisms are interdependent. For example, in a two-factor login described in accordance with one or more embodiments of the present invention, the first and second login mechanisms are interdependent to form a single login mechanism, i.e. they are unable to operate independently. Specifically, the login process in one-factor must be completed before the credentials (e.g. password) or user association (e.g. userid) is passed to the other and vice versa. Additionally, the network access medium employed by one of the authentication factors is normally the network access medium used by the authenticated user to access the resources available after login. Furthermore, as used herein, when additional factors are introduced to provide resource access control, the login mechanism is termed a multi-factor authentication.

While the various embodiments of the present invention find application in various types of systems, one specific application, namely the hospitality industry, is described herein for exemplary and illustrative purposes. Such a specific example is not to be considered as limiting. It should be noted that beyond the general basis, the various embodiments of the present invention covers various specific business applications for a login system, where a user calls an Interactive Voice Response (IVR) system and the IVR system is used as a user provisioning system to create an access code, userid and password or any other authentication credential(s), and the IVR system operator is able to identify the user from the call for billing purposes. The use of an IVR system to provide login credential(s) without requiring prior authentication is considered within the scope of the present invention.

In accordance with the various embodiments of the present invention, the various embodiments provide an authentication process which provides benefits such as:
(i) Two-factor authentication to avoid fraud;
(ii) Ease of use for the end user;
(iii) Low user account provisioning and maintenance costs; and
(iv) Low capital equipment investment cost.

The various embodiments of the present invention utilize portions of a telephone or communication system for a two-factor authentication to uniquely identify a location (telephone+extension number) and/or a user (mobile phone). For network elements such as portable computers that may freely roam in and out of a network, user account provisioning and maintenance is a major operational challenge due to the constantly changing user base over a relatively short duration. For example, the typical approach of assigning userid and passwords to hotel guests may become an operational complexity.

While it is possible to use the wired network point to identify the user, the popularity of wireless network access is diminishing the benefit both in cost and convenience of installing wired points in such business environments (i.e., one wireless access point can service, for example, multiple rooms with the cabling charges being essentially eliminated).

In accordance with the one or more embodiments of the present invention, an IVR system may be incorporated to provide a two-factor authentication process under the assumption the physical access to the mobile or fixed-wired phone is secured. In accordance with accepted security policies, this assumption is generally acceptable.

In accordance with the various embodiments and with an illustrative example specific to the hospitality example, the hotel operator is considered the trusted party, and the hotel guest accepts the bill generated by the hotel from third parties as well (e.g., restaurant, ISP etc). Extending this trust relationship, the IVR system deployed by the hotel is considered a trusted resource (e.g., you can request room service, laundry etc. from the IVR). Note, although the above example uses the hotel industry as an example, it does not preclude the use of the same approach for other industries, e.g., service apartments, wireless hotspots where the same solution statement concerns are valid.

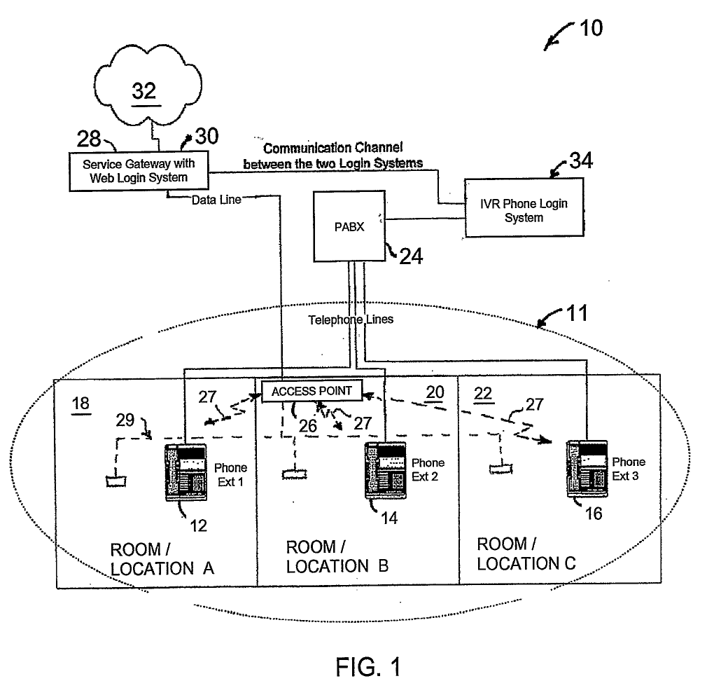

FIG. 1 is a block diagram of an access point network utilizing a two-factor login, in accordance with an embodiment of the present invention. A network 10 is configured to provide a two-factor authentication login process/system for network access, an example of which is Internet access. Network 10 includes one or more individual wired phones 12-16 in, for example, one or more corresponding locations or rooms 18-22. Each phone 12-16 includes a unique extension number associated therewith. The phone 12-16 lines are aggregated at, for example, a central Private Automatic Branch Exchange (PABX) phone system 24.

Network 10 further includes one or more access points 26 configured to facilitate an access service (e.g., Internet), for providing an Internet connection to one or more users. Access point 26 may be configured as a wireless access point configured to radiate and receive electromagnetic waves 27 over a coverage area 11. Alternatively, access point 26 may be configured as a wired access point configured to transmit and receive signals across a wired access point interface 29 over a coverage area 11. A single access point 26 may provide coverage to multiple rooms 18-22 or even public areas. If the access service is restricted to guests or paying customers, a service gateway 28 or similar equipment(s) may be used to provide the web login system 30 and service access controls to, for example, the Internet 32. It should be noted that the login factor may be alternatively provided through a delivery mechanism other than a conventional web login system. Such alternative delivery mechanisms include any network software client that may provide a user credential such as an IEEE 802.1x supplicant or Microsoft Windows Login client. If such an alternative network software client also provides a password or piece of information to confirm the user credential provided, the latter may be ignored in the implementation of this invention. For purposes of convenience in notation, such alternative authentication mechanisms are herein included within the scope of the current definition of the term “web-login system” as used herein. Since an access point 26 may cover multiple areas such as rooms 18-22, it is not reliable for the service gateway 28 to identify or associate a user's room 18-22 number by the servicing access point 26 providing communication with the associated computing device.

Network 10 further includes an IVR phone login system 34 coupled to the central PABX 24 to provide the additional login factor. The IVR phone login system 34 is configured to identify the user's room 18, 20 or 22 based on the unique phone extension number of each room 18-22. The IVR phone login system 34 communicates with the wireless service gateway 28 to provide an integrated two-factor authentication login system. It should also be noted that the additional login factor may be alternatively provided through a delivery mechanism other than a conventional IVR system. One such alternative delivery mechanism includes an electronic data delivery mechanism such as email or text messaging. For purposes of convenience in notation, such alternative delivery mechanisms are herein included within the scope of the current definition of an IVR system as used herein.

In accordance with the various embodiments of the present invention, a two-factor authentication process may be performed according to various processes. According to the architecture of network 10 of FIG. 1, the two-factor authentication process may be classified according to the configuration and usage of the IVR phone login system 34 as an “inbound” or “outbound” IVR phone login system. When IVR phone login system 34 is configured as an “inbound” IVR phone login system, the user initiates the phone call to the IVR phone login system 34. This configuration requires the user to know the IVR hunting line extension number to call and the IVR phone login system 34 needs to identify the incoming call extension number (e.g., caller-id). When IVR system 34 is configured as an “outbound” IVR system, the IVR phone login system 34 initiates the call to the user. The first-factor authentication process normally provides the room (18, 20 or 22) number to call and the call trigger. This implies the users do not need to know the IVR extension number, i.e., there is no need for a hunting line facility to support multiple concurrent logins. Neither does the IVR phone login system 34 need to support caller-id to identify the room number. However, since any user could provide the room (18, 20 or 22) number and trigger the call, inbound IVR phone login systems are more susceptible to end-user DoS (Denial of Service).

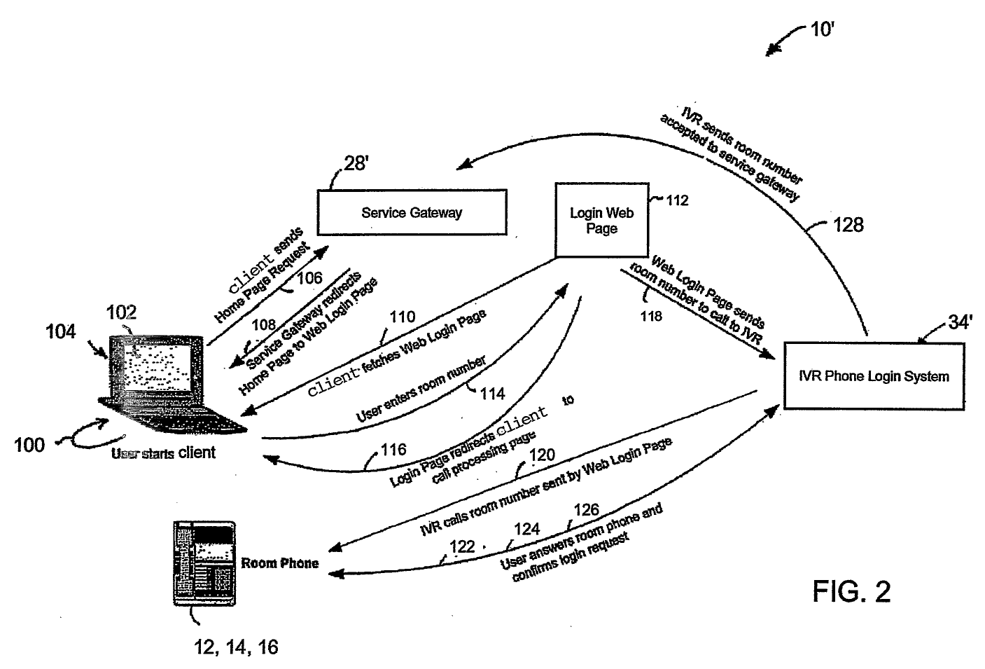

FIG. 2 is a flow diagram illustrating an IVR phone login system configured as an outbound IVR system in accordance with an embodiment of the present invention. In the present embodiment, the login sequence requests a second-factor authentication using an incoming phone call to a user. While FIG. 2 illustrates one possible two-factor authentication sequence using an outbound IVR phone login system 34′, there may be many permutations to this example that does not diverge from the two-factor authentication described herein and are considered to be within the scope of the present invention.

In accordance with the flow diagram of FIG. 2, a user starts 100 a web browser 102 on a wireless computing device 104. The web browser 102 sends 106 a request for home page through a service gateway 28′. The service gateway 28′ redirects 108 the home page request to a login page. The web browser 102 fetches 110 the login web page 112 from the service gateway 28′. The login web page 112 requests the user to enter a room number designating a specific one of rooms 18, 20 or 22 (FIG. 1). The user enters 114 a room number in the login web page 112 which associates the room number to the user's computing device 104 requesting the access. The login system of service gateway 28′ maps the user to the computing device's MAC address and location requesting the first factor login. The login web page 112 redirects 116 the web browser 102 to an IVR call processing page which provides an optional access code and informs the user to wait for a phone call. The login web page 112 also sends 118 the room number for calling to the IVR phone login system 34′. The IVR phone login system 34′ is triggered and calls 120 the room number provided by the user in the login web page 112. The user answers 122 the phone call and the IVR phone login system 34′ requests 124 the user to confirm 126 the login request, for example, press “1” to login, “2” to cancel. This is the second factor authentication. The user confirms 126 the login request, for example, by pressing, for example, “1”. The IVR phone login system 34′ informs 128 the service gateway 28′ that the login request for the user's room number is accepted. The service gateway 28′ processes the IVR login confirmation and opens Internet access to the user's computing device 104.

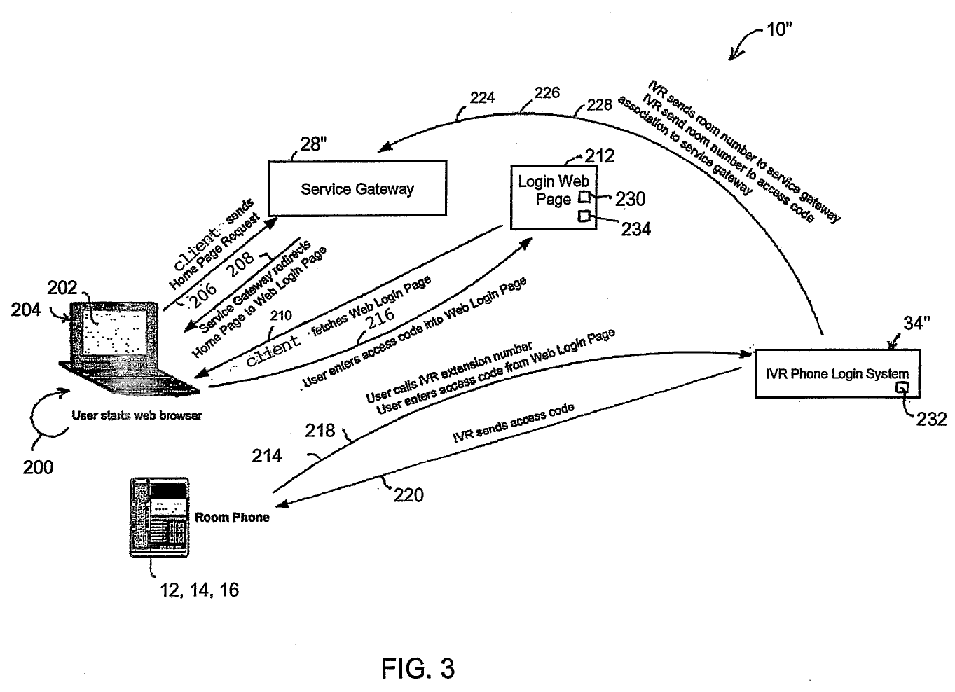

FIG. 3 illustrates another two-factor authentication sequence using an inbound IVR system, in accordance with another embodiment of the present invention. While one specific sequencing of message exchange is illustrated, many permutations to this example that do not diverge from the two-factor authentication described in this invention are also contemplated to be within the scope of the present invention.

In accordance with the flow diagram of network 10″ of FIG. 3, a user starts 200 a web browser 202 on a computing device 204. The web browser 202 sends 206 a request for a home page through a service gateway 28″. The service gateway 28″ redirects 208 the home page request to a login web page 212. The web browser 202 fetches 210 the login web page 212 and informs the user to use the room phone 12, 14, 16 to call 214 a particular extension number 230 which is the IVR hunting line number. The call allows the user to get 220 a first access code 232 from the IVR phone login system 34″ and enter 216 into the login web page 212. Alternatively, the call allows the user to enter 218 a second or unique access code 234 shown on the login web page 212 into the IVR phone login system 34″, or to enter the room number into the login page 212 and confirm the login request via the IVR phone login system 34″. A login system may implement and map the user to the computing device's MAC address and location requesting the first-factor login.

Continuing, the user calls 214 the IVR extension number. The IVR system identifies the room number of the incoming call and depending on the login process specified:
(1) Return a unique access code 232 to login via the web page and sends 224 the access code to room number association to the service gateway,
(2) Request for the access code provided by the web page to associate the computing device with the room number and send 226 the access code to room number association to the service gateway, or
(3) Automatically send 228 the room number to the service gateway.

Depending on the login process specified above, the user completes the second-factor authentication process by:
(1) Entering 218 the IVR generated access code 232 into the web login page 212,
(2) Entering the web login page generated access code 234 into the IVR, or
(3) Taking no further action.

Depending on the login process specified immediately above, the service gateway will verify the second-factor login request by:
(1) Checking if the access code received via the login page matches an access code returned by the IVR,
(2) Checking if the access code received from the IVR matches a previously generated access code, or
(3) Checking if the room number received from the IVR matches a room number previously received via the web page.

If the second-factor authentication process is successful, the service gateway 28″ will open up Internet access for the user's computing device 204.

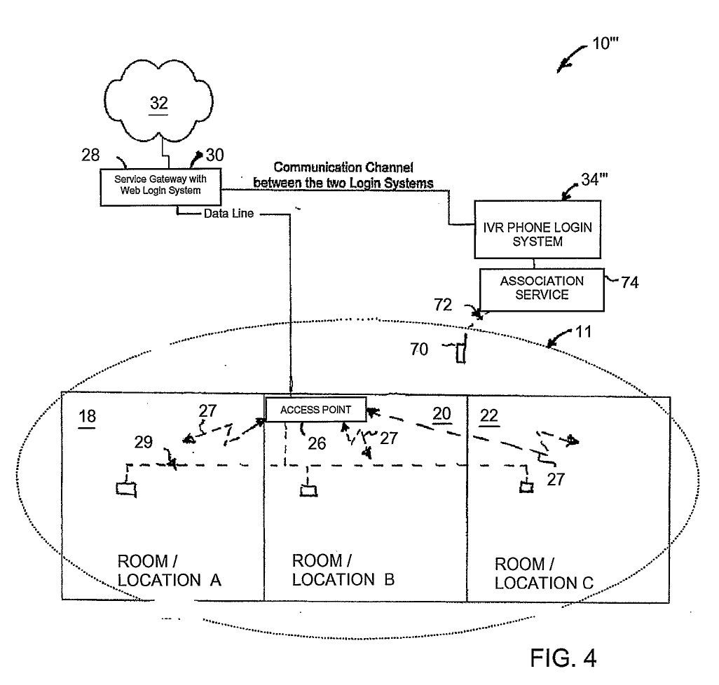

FIG. 4 is a block diagram of an access point network utilizing a wireless phone as part of an authentication process, in accordance with yet another embodiment of the present invention. In the previous embodiments described with reference to FIG. 2 and FIG. 3, the telephone device for facilitating the authentication process is fixed within the location of a room. Therefore, the IVR system knows specifically where either a call originates or terminates and can correlate a room and user to the specific room phone. A wireless telephone may be utilized for either embodiment as a replacement for the wired room phone. Specifically, during, for example, a room registration process, the user's number 72 of wireless phone 70 is associated to a specific one of rooms 18-22 and is recorded or made available to the login system 34″′ by an association service 74. The authentication process of either FIG. 2 (outbound IVR system) or FIG. 3 (inbound IVR system) may be used to authenticate the user except the user's mobile phone 70 replaces the room phone 12-16 (FIG. 2 and FIG. 3). The present embodiment enables the user to initiate his or her first login attempt outside the rooms 18-20.

Additional embodiments of the present invention may include an IVR system configured to provide more detailed services, e.g., QoS, or usage duration for the computing device. Additionally, through transaction tracking, each web login request may be uniquely associated to an IVR login confirmation. For example, duplicate web login requests from the same computing device should be discarded while there is a pending IVR login confirmation active. Similarly, outstanding web login requests that have “timed-out” should be discarded, e.g., user does not answer the phone call. Additionally, to outsource billing and payment collection, the inbound IVR system could be a registered 190x paid phone service. An established telecommunication service provider could then handle the billing and payment collection.

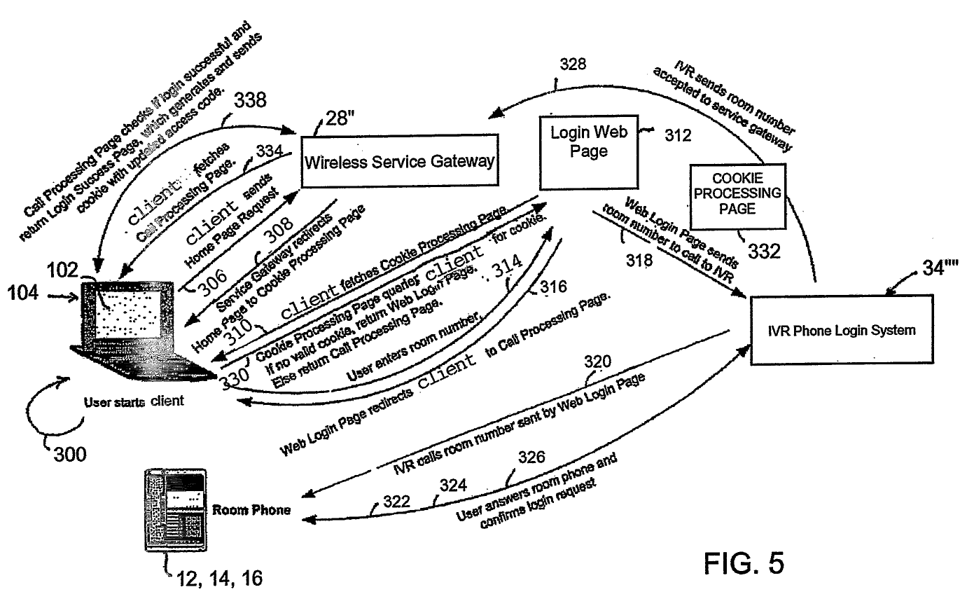

FIG. 5 is a flow diagram of a two-factor authentication process including a persistent login capability in accordance with a further embodiment of the present invention. Since the computing device-to-room relationship is established after the two-factor authentication process of the one or more embodiments described with respect to FIGS. 1-4, the access code (generated by the IVR system or returned by the web login page) or a cookie generated (generated by the web login sequence) and stored on the computing device web browser may be used to provide a persistent login token associated with the computing device within an allowed usage duration. This persistent login is possible because the service gateway can use the access code or cookie to correlate the room number and permitted usage duration.

The user can then use the access code or cookie from locations other than the specific room, or use, for example, an NIC (network interface card) on the computing device where the phone to billing relationship or MAC (media access control) address to billing relationship etc cannot be established. Note if the cookie stored on the computing device is used as the only login credential for subsequent authentication, the end user does not need to remember any other login credentials; while if the access code is used for subsequent authentication, the user is not restricted to just using the same computing device.

Continuing with respect to FIG. 5, FIG. 5 illustrates a flow diagram of a two-factor authentication sequence using an outbound IVR system and a web-based cookie, in accordance with another embodiment of the present invention. FIG. 5 illustrates an IVR system configured as an outbound IVR system in accordance with an embodiment of the present invention. In the present embodiment, the login sequence requests second-factor authentication using an incoming phone call. While FIG. 5 illustrates one possible two-factor authentication sequence using an outbound IVR phone login system 34″″, there may be many permutations to this example that do not diverge from the two-factor authentication described herein and are considered to be within the scope of the present invention.

In accordance with the flow diagram of FIG. 5, a user starts 300 a web browser 102 on a computing device 104. The web browser 102 sends 306 a request for a home page through a service gateway 28″. The service gateway 28″ redirects 308 the home page request to a cookie processing page 332. The web browser 102 fetches 310 the cookie processing page 332 from the service gateway 28″. The cookie processing page 332 queries 330 the web browser 102 for a cookie. If no valid cookie exists, then processing returns to the web login page 312, else it returns 334 to the call processing page. The call processing page checks to see if the login is successful and returns 338 a Login Success Page. The login page 312 requests the user to enter 314 a room number designating a specific one of rooms 18, 20 or 22 (FIG. 1). The user enters 314 a room number in the login page 312 which associates the room number to the user's computing device 104 requesting the access. The login system of service gateway 28″ maps the user to the computing device's MAC address and location requesting the first factor login. The web login page 312 redirects 316 the web browser 102 to a call processing page which provides an optional access code and informs the user to wait for a phone call. The web login page 312 also sends 318 the room number for calling to the IVR phone login system 34″″. The IVR phone login system 34″″ is triggered and calls 320 the room number provided by the user in the login web page 312. The user answers 322 the phone call and the IVR phone login system 34″″ requests 324 the user to confirm 326 the login request (e.g., press “1” to login, “2” to cancel). This is the second factor authentication. The user confirms 326 the login request, for example, by pressing, for example, “1”. The IVR phone login system 34″″ informs 328 the service gateway 28″ the login request for the user's room number is accepted. The service gateway 28″ processes the IVR login confirmation and opens Internet access to the user's computing device 104.

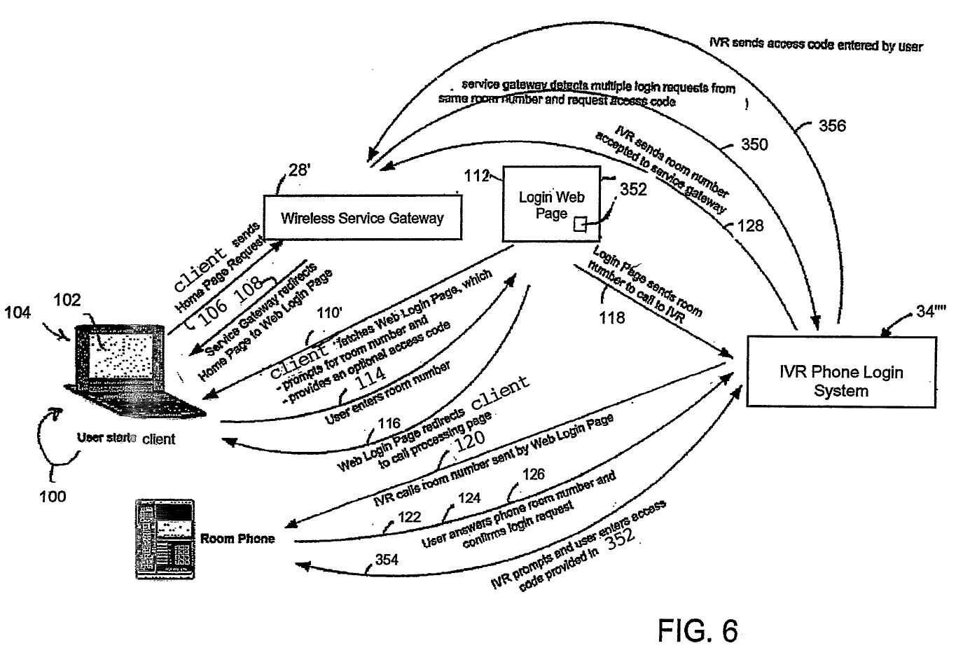

FIG. 6 illustrates a flow diagram of a two-factor authentication process with an outbound IVR system for multi-user and/or denial of service (DoS) conditions, in accordance with yet another embodiment of the present invention. In the login process of FIG. 2 using an outbound IVR system, the act 120 where the login system of the IVR phone login system 34′ initiates 120 the phone call to the user phone 12, 14, 16 may be susceptible to DoS (Denial of Service) due to forgery of the first-factor identification (e.g., room number). This DoS can be handled by userid fraud detection techniques. For example, when the user receives an unsolicited login confirmation phone call by the login system of IVR phone login system 34′, the user can deny the login request and the login system can “blacklist” the MAC address of the user's computing device 104 that triggered the second-factor authentication. Validity or sanity checks should also be performed on the first-factor authentication attribute, e.g. if an access point coverage area 11 (FIG. 1) does not reach a particular room number entered or in the wired embodiment, the cabling does not extend into a particular room, the initial authentication attribute entered by a user cannot be valid, or if a room number is already scheduled to be called, the same request should be rejected.

Returning to FIG. 6, when a user wishes to login to the system while under DoS, exception handling can be provided at a minimal expense to the ease of login. The login system could detect 350 multiple first-factor login requests from different computing devices (e.g. different MAC addresses) that are still actively connected to the network. In such conditions, the optional access code 352 is required. After the initial web login request 106-116 (the first-factor) wherein an access code is additionally fetched 110′, the IVR system (the second-factor) phone call 122-126 to the user room will request 354 for the access code 352 if login is requested. That access code is then sent 356 and used to identify the correct computing device out of the multiple others requesting login using the same first-factor attribute. Note, in such situations, the login web page 112 that triggered the phone call to the user need not be from the actual user's computing device, e.g. it can be from a computing device launching the DoS.

If end user DoS is a major concern, the process of FIG. 3 of the sample login process using inbound IVR systems may provide improved performance. In that process, the user, instead of the login system, initiates the phone call, however, there may be a minor compromise between the end user's ease of use versus the potential end user's DoS vulnerability. However, according to such an approach, the inbound IVR system itself is susceptible to DoS, e.g. all the available hunting lines are occupied. Preventing such DoS is relatively achievable as:
(1) Incoming calls can be restricted to only specific phones. In comparison, it is difficult to restrict the service to specific computing devices;
(2) Actual source of the DoS can be easily traced and the user identified; and
(3) Multiple phones, which imply multiple rooms, are required to launch the DoS. In comparison, the computing devices launching a DoS might not even belong to the facility encompassing the rooms.

Additionally, if the authentication process of FIG. 3, namely matching room number entered in the web login page with the incoming phone call extension number to verify the login, is used under DoS or multi-user conditions, the login web page may provide an access code for the user to enter into the IVR system. The IVR system will then prompt the user for the web page access code if the login system detects multiple login requests from different computing devices with the same room number.

It should be noted that while inbound IVR systems can handle DoS better than outbound IVR systems, at high load conditions, the reverse is true. When there is a high number of concurrent logins, with the same number of telephone lines to the IVR system, if all the telephone lines are occupied, an outbound IVR system can queue the outstanding phone calls to the users while an inbound IVR system will starting dropping phone calls from users.

Similar to the above situation, with the popularity of the wireless medium or network computing, there exist situations when access to restricted resources is on a temporary basis via an unregulated user's computing device, and when accessing such resources, due to confidentially or security reason etc, access to other independent resources normally available to the user must be denied. For example, when the resource to be access is a secured resource where security is a concern, besides preventing the user from accessing other unsecured resources (e.g. Internet) concurrently, there is a need to prevent third parties from using the user's computing device to a relay attack on the secure resource or compromise the resource confidentially. Alternatively, there could be multiple groups of users, such that while one group needs to access a particular restricted resource, other groups are not allowed to access the latter resource. There may be a need to prevent (potentially deliberate) user identity fraud when two different group exchange login credentials.

Integrating two-factor authentication with the additional factors provides a multi-factor authentication process that applies the original login solution for access control to restricted resources. In multi-factor authentication—unlike two-factor authentication—the user identifier (e.g. userid, room number) and the user verification credential (e.g. password, access code) could both be provided by one of the two factors, although this is not required.

Additional security factors may be incorporated including: (a) Providing the login credentials to the authorized user only at the specific time the user requires access to the restricted resource. Each login credential uniquely identifies the user and can only be used to login once; (b) Using a limited permissible login time window to ensure all authorized users will login immediately on receiving the login credential; (c) Automatically logging out the user if the computing device disconnects from the network access medium or the permitted usage time period has expired; and (d) Not allowing the user to login again using the same login credential provided in Step (a) even if the permitted usage time has not expired. Steps (a) and (b) above when combined prevent or at least minimize the opportunity for the authorized user to exchange or expose the login credential to another unauthorized user group or users within the authorized group.

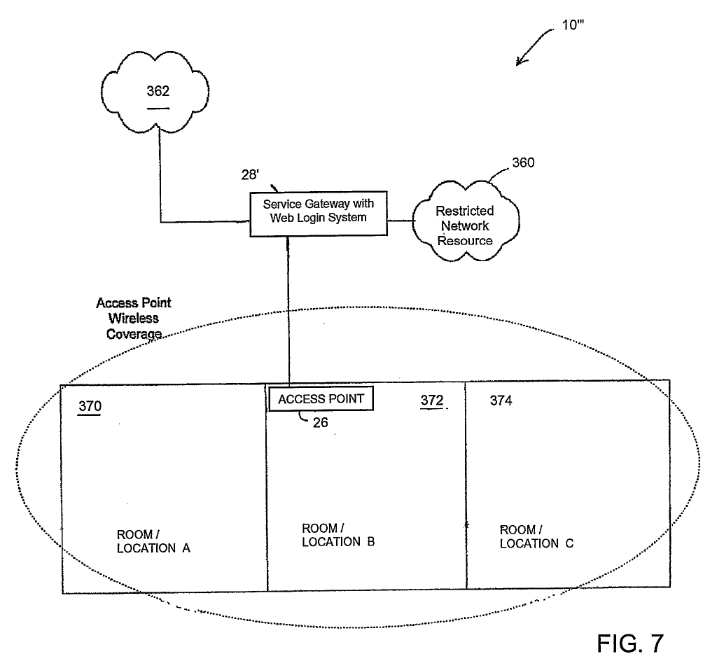

FIG. 7 is a block diagram of a network configured to restrict access to at least a portion of the available resources, in accordance with yet another embodiment of the present invention. In one particular application, for example, a campus may allow students to access examination questions online (a restricted resource) 360 and allow them to complete the questions using a wireless electronic device. For fairness, all the users are not allowed to access the network 10″′ before the examination begins, and access to the questions (and ability to provide further answers) are cut off once the examination time period expires. Concurrently, students from different faculties or even members of the public may also be allowed to access the same campus wireless network non-restricted resources 362.

By way of example, first-factor authentication can be an authentication mechanism (e.g. web-based userid and password login) used to login to the network. This first-factor login credential identifies:
(1) The computing device;
(2) The user identity if the userid is provided; and
(3) The user to computing device association if the userid is provided.

Note in concept, only the userid (or any other user identifying attribute) is required if it is not provided for in the second-factor authentication. The password (or any other login verification credential) is not required and may be ignored. The current authentication mechanism of network 10″′ is retained so that other users—who do not need access to the restricted resources 360—can continue to login and gain access to the Internet or unrestricted resources 362. If the user identity is known and the user is required to access the restricted resources 360 at that time, the user may be denied Internet access and can only initiate the second-factor authentication process.

In the current examination example, the invigilator could be the second-factor authentication “device”. Prior to the examination, the invigilator could distribute the unique login credentials created for each examinee. These login credentials would minimally provide a unique one-time password. This list of passwords can be randomly generated by the service gateway and their valid time window can be configured in the service gateway 28′. The service gateway 28′ can then perform the userid to password validity checks based on the additional factors.

Each examinee uses the login credentials provided to login and access the restricted examination questions. Single sign-on solutions could be integrated to the network login system such that the examinee identity will also be known to the examination server. Each examinee can then only complete and submit under their identity, i.e. they cannot switch identities. Furthermore, during the examination period, while the user can gain access to the questions posted on the network, they cannot access the Internet to help them find answers, or allow communications with external parties or between authorized users. After the examination period, the students can gain normal access to the Internet or other unrestricted network resources 362. Another applicable use of such multi-factor authentication process could be in computerized contests.

Continuing the present examination example, Location B 372 could be the examination hall with the coverage area extending to Location A 370 and Location C 374. A service gateway 28′ implements the login system and access controls to both the Internet (unrestricted resources 362) and the restricted resources 360 (e.g. examination server). The service gateway 28′ provides the only connection to the restricted resources 360, i.e. all traffic to and from the restricted resource 360 must pass through the service gateway 28′. In a normal usage scenario, end users in Location A and C could be accessing the Internet while users in Location B can only access the restricted resources.

Although the foregoing description contains many specifics, these are not to be construed as limiting the scope of the present invention, but merely as providing certain exemplary embodiments. Similarly, other embodiments of the invention may be devised which do not depart from the spirit or scope of the present invention. The scope of the invention is, therefore, indicated and limited only by the appended claims and their legal equivalents, rather than by the foregoing description. All additions, deletions, and modifications to the invention, as disclosed herein, which fall within the meaning and scope of the claims are encompassed by the present invention.

1. A method for authenticating a user in a network, comprising:
requesting from a network software client of a computing device a network software service on a service gateway;
initiating a call between a user phone and an IVR phone login system in response to the user phone and the computing device being within a coverage area of the service gateway;
identifying the user associated with a location within the coverage area of the service gateway as uniquely assigned to the computing device;
completing the collection of a first information received by the network software service from the computing device before asynchronously initiating the collection of a second information received from the IVR phone login system;
correlating the first information and the second information; and
when the first and second information match, allowing access by the computing device to services of the service gateway.

2. The method of claim 1, wherein the network software client is a web browser and the network software service is a web server.

3. The method of claim 2, further comprising entering a room number into the network software service to identify the location uniquely assigned to the computing device.

4. The method of claim 3, wherein initiating a call comprises said IVR phone login system initiating a call to a user phone in response to the room number entered in the network software service.

5. The method of claim 3, wherein the user phone confirms a login request during the call with the IVR phone login system.

6. The method of claim 4, wherein correlating comprises the IVR phone login system comparing the room number received from the network software service with a phone number used to initiate the call by the IVR phone login system to the user phone.

7. The method of claim 1, wherein the identifying the user associated with a location comprises divulging a room number assigned to the computing device.

8. The method of claim 1, wherein the network software service comprises a phone number designating the IVR phone login system.

9. The method of claim 8, wherein the initiating a call comprises the user phone initiating the call to the IVR phone login system according to the phone number.

10. The method of claim 9, wherein the initiating a call further comprises the IVR phone login system sending an access code to the user phone.

11. The method of claim 10, wherein the computing device enters the access code into the network software service.

12. The method of claim 8, wherein the identifying a location comprises the IVR phone login system correlating a callerid from the call originating from the user phone.

13. The method of claim 11, wherein correlating comprises the service gateway comparing the access code received at the network software service with the access code originating at the IVR phone login system.

14. The method of claim 1, wherein the user phone is wired within the location within the coverage area.

15. The method of claim 1, further comprising associating a wireless phone number with the location and wherein the user phone is a wireless phone.

16. The method of claim 1, wherein the computing device is a wireless computing device configured to wirelessly couple to the service gateway.

17. The method of claim 1, further comprising providing log in credentials to the user to access restricted network resources.

18. An authentication system, comprising:
a computing device including a network software client configured to request a network software services;
a gateway configured to host the network software services and further configured to redirect the network software client to request the network software services from the service gateway;
a user phone;
an IVR phone login system configured to support a call with the user phone when the user phone and the computing device is located within a coverage area of the service gateway as uniquely assigned to the computing device; and
the service gateway and the IVR phone login system further configured to correlate a first information received in the network software services from the computing device and a second information received from the IVR phone login system and when the first and second information match, allowing access by the computing device to services of the service gateway.

19. The authentication system of claim 18, wherein the network software client is a browser and the network software services is a web network software service.

20. The authentication system of claim 19, further comprising an access point coupled to the service gateway, the access point configured to generate the coverage area.

21. The authentication system of claim 20, wherein the access point is further configured as a wireless access point and the computing device is further configured as a wireless computing device.

22. The authentication system of claim 19, wherein the IVR phone login system is further configured to initiate a call to a user phone in response to the room number entered in the web network software service.

23. The authentication system of claim 22, wherein the user phone is further configured to confirm a login request during the call with the IVR phone login system.

24. The authentication system of claim 23, wherein the IVR phone login system is further configured to compare the room number received from the network software service with a phone number used to initiate the call by the IVR phone login system to the user phone.

25. The authentication system of claim 19, wherein the web network software service comprises a phone number designating the IVR phone login system.

26. The authentication system of claim 25, wherein the user phone is further configured to initiate the call to the IVR phone login system according to the phone number.

27. The authentication system of claim 19, wherein the IVR phone login system is further configured to send an access code to the user phone.

28. The authentication system of claim 27, wherein the computing device is further configured to enter the access code into the network software service.

29. The authentication system of claim 26, wherein the IVR phone login system is further configured to correlate a callerID from the call when originating from the user phone.

30. The authentication system of claim 19, wherein the user phone is configured as a wired phone within the location within the coverage area.

31. The authentication system of claim 19, wherein the user phone is configured as a wireless phone.

32. A computer-readable medium having computer-executable instructions thereon for authenticating a user in a network, the computer-executable instructions for performing the acts of:
requesting from a network software client of a computing device a network software service on a service gateway;
initiating a call between a user phone and an IVR phone login system in response to the user phone and the computing device being within a coverage area of the service gateway;
identifying the user associated with a location within the coverage area of the service gateway as uniquely assigned to the computing device;
completing the collection of a first information received by the network software service from the computing device before asynchronously initiating the collection of a second information received from the IVR phone login system;
correlating the first information and the second information; and
when the first and second information match, allowing access by the computing device to services of the service gateway.

33. The computer-readable medium of claim 32, wherein the network software client is configured as a web browser and the network software service is configured as a web server.

34. The computer-readable medium of claim 33, further comprising computer-executable instructions for entering a room number into the network software service to identify the location uniquely assigned to the computing device.

35. The computer-readable medium of claim 34, comprising computer-executable instructions wherein initiating a call comprises the IVR phone login system initiating a call to a user phone in response to the room number entered in the network software service.

36. The computer-readable medium of claim 34, comprising computer-executable instructions wherein the user phone confirms a login request during the call with the IVR phone login system.

37. The computer-readable medium of claim 35, comprising computer-executable instructions wherein correlating comprises the IVR phone login system comparing the room number received from the network software service with a phone number used to initiate the call by the IVR phone login system to the user phone.

38. The computer-readable medium of claim 33, comprising computer-executable instructions wherein the identifying the user associated with a location comprises divulging a room number assigned to the computing device.

39. The computer-readable medium of claim 33, comprising computer-executable instructions wherein the network software service comprises a phone number designating the IVR phone login system.

40. The computer-readable medium of claim 39, comprising computer-executable instructions wherein the initiating a call comprises the user phone initiating the call to the IVR phone login system according to the phone number.

41. The computer-readable medium of claim 40, comprising computer-executable instructions wherein the initiating a call further comprises the IVR phone login system sending an access code to the user phone.

42. The computer-readable medium of claim 41, comprising computer-executable instructions wherein the computing device enters the access code into the network software service.

43. The computer-readable medium of claim 39, comprising computer-executable instructions wherein the identifying a location comprises the IVR phone login system correlating a callerId from the call originating from the user phone.

44. The computer-readable medium of claim 42, comprising computer-executable instructions wherein correlating comprises the service gateway comparing the access code received at the network software service with the access code originating at the IVR phone login system.

45. The computer-readable medium of claim 32, comprising computer-executable instructions wherein the user phone is wired within the location within the coverage area.

46. The computer-readable medium of claim 33, the computer-executable instructions further comprising associating a wireless phone number with the location and wherein the user phone is a wireless phone.

47. The computer-readable medium of claim 33, comprising computer-executable instructions for providing login credentials to the user to access restricted network resources.
